(19) United States
(12) Patent Application Publication
(10) Pub. No.: US 2025/0141539 A1
(43) Pub. Date: May 1, 2025

(54) LOCATION-BASED SCHEDULING OF COMMUNICATIONS NETWORK OPERATIONS

(71) Applicant: HUAWEI TECHNOLOGIES CO., LTD., SHENZHEN (CN)

(72) Inventors: William Carson MCCORMICK, Kanata (CA); Mehdi Arashmid AKHAVAIN MOHAMMADI, Kanata (CA); Peter ASHWOOD-SMITH, Kanata (CA)

(73) Assignee: HUAWEI TECHNOLOGIES CO., LTD., SHENZHEN (CN)

(21) Appl. No.: 19/004,764

(22) Filed: Dec. 30, 2024

Related U.S. Application Data
(63) Continuation of application No. PCT/CN2022/105365, filed on Jul. 13, 2022.

(51) Int. Cl. H04B 7/185

(52) U.S. Cl. CPC H04B 7/18532; H04B 7/18547; H04B 7/18589

(57) ABSTRACT

Service disrupting operations for a mobile node (e.g. a LEO or MEO satellite) are scheduled to automatically take place when the platform is at a certain location or enters a region. Service disrupting operation may be performed, and the mobile node taken out of service, when the mobile node's physical location matches a target region, at which the services of the mobile node are not in high demand. Alternatively, service disrupting operation may be performed when the mobile node is proximate to a ground station which facilitates the associated service disruption. The service disruption may correspond to a reconfiguration for purposes of serving a different regional communication network.

### CROSS-REFERENCE TO RELATED APPLICATIONS

This application is a continuation of International Patent Application No. PCT/CN2022/105365, filed Jul. 13, 2022, entitled “Location-Based Scheduling of Communications Network Operations” the contents of which are incorporated herein by reference in its entirety.

### TECHNICAL FIELD

The present invention pertains in general to communication networks, such as satellite networks, and in particular to a method and apparatus for scheduling of operations within a communications network, for example by configuring nodes thereof.

### BACKGROUND

Network and network node service disrupting operations are typically scheduled based on the time of day or on network connectivity. For example, some software upgrades are scheduled at off-peak hours, such as between midnight and 4:00 AM in North America. In another example, Windows® updates are often scheduled for 1:00 AM when demand is expected to be low for most users.

Mobile node (e.g. satellite) networks introduce new challenges and constraints in scheduling service disrupting operations. A mobile satellite constellation potentially spans the whole world where off-peak hours are inherently inapplicable. This can render time-based service disrupting operation scheduling problematic and potentially unfeasible.

Therefore there is a need to provide a method and apparatus that obviates or mitigates one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present invention is to provide a method, apparatus and system for scheduling of communication network operations, particularly mobile node (e.g. satellite) service disrupting operations (e.g. operations that affect one or more services provided by or via the mobile node), where the scheduling is based at least in part on mobile node location. Mobile nodes such as satellites can be triggered to perform service disrupting operations when they are at a location where operational demand on the mobile node is relatively low. In this way, the impact of associated service disruption (which can reduce or suspend mobile node capabilities) is reduced. Additionally or alternatively, the service disrupting operation can be triggered when a mobile node is at a convenient location, such as near a ground station, to facilitate communication which may be required for the service disrupting operation. The mobile node can monitor its own location (or receive location indications) and self-trigger service disrupting operations based on same.

According to an embodiment of the present disclosure, there is provided a networked computerized system for scheduling service disrupting operations. The system may include one or more non-terrestrial mobile nodes of a network. At least one of the one or more mobile nodes may include a location service module configured to determine a present physical location of the at least one of the one or more mobile nodes. At least one of the mobile nodes may include a system management module configured to initiate at least one service disrupting operation requiring a suspension or reduction in operational capacity of at least one of the mobile nodes. The initiating is based at least in part on the present physical location being at a target physical location

According to another embodiment of the present disclosure, there is provided a system management networked computerized device configured to determine at least one service disrupting operation to be initiated by the system management device when one or more non-terrestrial mobile nodes of a network are at a target physical location. The at least one service disrupting operation requires a suspension or reduction in operational capacity of the one or more mobile nodes. The system management device may further determine that at least one of the one or more mobile nodes is at the target physical location and, in response to such determining, initiate the at least one service disrupting operation. The determining may include receiving a notification of the target physical location from a (e.g. ground) control centre or another device. The determining may include receiving an indication of a present physical location of the at least one of the one or more mobile nodes from one or more of: a (e.g. ground) control centre; a location service module of the at least one of the one or more mobile nodes; and another device. The determining may include sending a target location request that includes the target physical location of the at least one of the one or more mobile nodes to a location service module.

According to another embodiment of the present disclosure, there is provided a location service networked computerized device located within the non-terrestrial mobile node of a network. The location service device may receive a target location request from the system management module that includes the target physical location of the mobile node. The location service device may further determine if the present physical location of the mobile node is at the target physical location and the location service device may send a target location indication to the system management module when the present physical location of the mobile node is at the target physical location. In response to receiving the target location indication, the system management module may initiate at least one service disrupting operation.

A technical effect of the above embodiments is that a mobile network node, such as a satellite, can be made to undergo a service disrupting operation, such as a maintenance or reconfiguration operation, based on physical location rather than another factor such as time. The physical location can be chosen so that impact of the service disruption is limited or minimized.

In embodiments, the system management module may identify the target physical location of the at least one of one or more mobile nodes.

In embodiments, the system management module schedules, based at least in part on the target physical location, one or more of: the at least one service disrupting operation; a pause of the at least one service disrupting operation; and a continuation of the at least one service disrupting operation.

In embodiments, the system management module may pause the at least one service disrupting operation based at least in part on the present physical location of the at least one of the one or more mobile nodes leaving the target physical location or the present physical location being at a second target physical location different from the target physical location. The system management module may further resume the at least one service disrupting operation based at least in part on the present physical location of the at least one of the one or more mobile nodes returning to the target physical location or the present physical location being at a third target physical location different from the target physical location and the second target physical location. A technical effect is that a service disrupting operation can be achieved in multiple separate steps when the mobile node is at multiple different physical locations, each potentially chosen so that impact of the service disruption is limited.

In embodiments, the non-terrestrial mobile nodes may be satellites. The satellites may be one or a combination of: a low-earth orbit (LEO) satellite constellation, a plurality of LEO satellite constellations, a hybrid satellite constellation comprising LEO satellites and medium earth orbit (MEO) satellites, or a satellite constellation comprising LEO satellites and geostationary earth orbit (GEO) satellites.

In embodiments, the target physical location may be a physical location at which operational demand on said at least one of the one or more mobile nodes is anticipated to be below a predetermined threshold. The target physical location may be a physical location at which the at least one of the one or more mobile nodes is proximate to a ground station facilitating the at least one service disrupting operation.

In embodiments, the system management module may send a target location request to the location service module that includes at least the target physical location of the at least one of the one or more mobile nodes. The location service module may receive the target location request from the system management module, or a ground control centre, or both. In response to receiving the target location request, the location service module may send a target location indication to the system management module, when the present physical location of the at least one of the one or more mobile nodes is at the target physical location.

In embodiments, the location service module may determine and further communicate an indication of the present physical location to the system management module. The system management module may receive the indication of the present physical location and determine that the present physical location is at the target physical location based at least in part on such indication. Additionally or alternatively, the location service module may determine that the present physical location is at the target physical location, and communicate an indication of this to the system management module.

In embodiments, the service disrupting operation may be a network configuration operation. The network configuration operation may include configuring the at least one of the mobile nodes to cease providing of a communication service associated with a first network of a first region, and to begin providing of the communication service or another communication service, associated with a second network of a second region. The first region may be associated with the first network, the second region may be associated with the second network, and the target physical location may be between the first region and the second region.

According to another embodiment of the present disclosure, there is provided a method for scheduling (e.g. service disrupting) network operations that includes obtaining, by the system management module, information indicative of current status of non-terrestrial mobile nodes of a network, links between the mobile nodes, or a combination thereof. Such a method may further include processing the information to determine a network configuration based on the obtained information. The network configuration may be implementable in the network by adjusting one or more of the mobile nodes, one or more of the links between the mobile nodes, or a combination thereof. The system management module may schedule such adjusting to be implemented when the one or more mobile nodes are in a target physical location.

In embodiments, the service disrupting operation may be a mobile node link configuration operation. The mobile node link configuration operation may include adjusting the at least one of the mobile nodes, one or more of the links between the mobile nodes, or a combination thereof, when the at least one of the mobile nodes is at the target physical location.

In embodiments, the service disrupting operation may be one or a combination of: a mobile node configuration operation; a mobile node self-test operation; a mobile node update operation; and a restart operation of one or more functions of the at least one of the one or more mobile nodes.

According to another embodiment of the present disclosure, there is provided a computer program product that includes instructions which, when executed by a computer, cause the computer to implement any of the methods, fully or in part, as disclosed herein.

Embodiments have been described above in conjunctions with aspects of the present invention upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE DRAWINGS

Further features and advantages of the present invention will become apparent from the following detailed description, taken in combination with the appended drawings, in which:

FIG. 1 illustrates a system for scheduling service disrupting operations, according to an embodiment of the present disclosure.

FIG. 2 illustrates an example of a present physical location of a mobile node being at a target physical location, according to an embodiment of the present disclosure.

FIG. 3 illustrates an example of a present physical location of multiple mobile nodes being at a target physical location, according to an embodiment of the present disclosure.

FIG. 4A illustrates an example of target physical locations and associated mobile nodes, according to an embodiment of the present disclosure.

FIG. 4B illustrates an example of target physical locations and associated mobile nodes, according to another embodiment of the present disclosure.

FIG. 5 illustrates an example method for scheduling mobile node service disrupting operations, according to an embodiment of the present disclosure.

FIG. 6A illustrates operations for the location-based triggering of service disrupting operations, with focus on a system management module, according to an embodiment of the present disclosure.

FIG. 6B illustrates operations for the location-based triggering of service disrupting operations, with focus on a location service module, according to another embodiment of the present disclosure.

FIG. 6C illustrates operations for the location-based triggering of service disrupting operations, with focus on a location service module and a system management module, according to another embodiment of the present disclosure.

FIG. 6D illustrates operations for the location-based triggering of service disrupting operations, particularly with respect to mobile node or link adjustment, according to another embodiment of the present disclosure.

FIG. 7A illustrates an example of links of mobile nodes of a network in a geometric mesh network arrangement before a link configuration, according to an embodiment of the present disclosure.

FIG. 7B illustrates an example of links of mobile nodes of a network in a geometric mesh network arrangement after a link configuration, according to an embodiment of the present disclosure.

FIG. 8 illustrates an example of a mobile node being at a target physical location between two regions, according to an embodiment of the present disclosure.

FIG. 9 illustrates an apparatus provided in accordance with an embodiment of the present disclosure.

It will be noted that throughout the appended drawings, like features are identified by like reference numerals.

### DETAILED DESCRIPTION

Embodiments of the present disclosure pertain to methods, apparatus and systems used to schedule service disrupting operations in networks having mobile nodes, such as in satellite constellations. The operations are scheduled based on mobile node physical location, for example satellite orbital position.

A notable aspect in embodiments of the present disclosure is the notion of scheduling service disrupting operations based on mobile node (e.g. satellite) location. For example, disruption to the system is expected to be limited or minimal when a satellite is located over a region where operational demand on the satellite is also limited or minimal. Such regions may be, for example, a polar region, or over an ocean, but away from shipping lanes. Thus, service disrupting operations may be scheduled to be performed when a satellite is in such locations. Accordingly, satellites, such as those in a Low Earth Orbit (LEO) constellation may be subjected to (e.g. regular or irregular) service disrupting operations which potentially disrupt or affect the service provided by or via the satellite(s), while these operations are scheduled so as to limit or minimize such disruptions.

In various embodiments, service disrupting operations may also be scheduled to be conducted when the mobile node (e.g. satellite) is located so that it has a direct connection to a management system. This may occur for example when the satellite is passing over one or more specific components external to the satellite, such as ground stations, control centers or other devices. This facilitates service disrupting operations which may require lower-latency or more reliable communication with such specific external components.

Other activities may also be scheduled based on mobile node (e.g. satellite) location. For example, a satellite may have usage restrictions on a per country basis. Accordingly, the satellite may be reconfigured when it is transitioning between physical locations over different countries in which different communication services utilizing the mobile node may be provided, by different network operators operating on different frequencies, for example.

In embodiments, the mobile nodes of the network are non-terrestrial, i.e. not supported by ground or water. The mobile nodes of the network may be satellites in Earth orbit. In such embodiments the mobile nodes may follow a predictable orbital path due primarily for example to satellite inertia. Alternatively, the mobile nodes may be floating or flying at a given altitude above Earth.

In various embodiments, the mobile nodes of the network may be or may include a low-earth orbit (LEO) satellite, satellite constellation, or a plurality of LEO satellite constellations. Such a plurality of constellations may involve, for example, multiple trains of LEO satellites, where each train includes multiple satellites being spaced apart and following a same or similar orbital trajectory at a same or similar altitude.

In various embodiments, the mobile nodes of the network may be or may include a hybrid satellite constellation of LEO satellites and medium earth orbit (MEO) satellites. This may involve, for example, multiple trains of LEO satellites, where certain trains may be in communication with specific MEO satellites at different stages of an orbit.

In various embodiments, the mobile nodes of the network may be or may include a hybrid satellite constellation of LEO satellites and geostationary earth orbit (GEO) satellites. This may involve, for example, multiple trains of LEO satellites, where certain trains may be in communication with specific GEO satellites at different stages of an orbit. It is noted that the GEO satellites are generally not expected to be at different physical locations (relative to Earth's surface) at different times, and thus service disrupting operations at these nodes are not necessarily scheduled based on their present physical location. However, service disrupting operations at these nodes may potentially be scheduled based on the present physical location of other mobile nodes.

In embodiments, service disrupting operations of a mobile node, or service disrupting operations involving the mobile node, are scheduled based on the event that a present physical location (e.g. ephemeris) of the mobile node is at a target physical location (which may be a point, arc segment, or spatial region). The present physical location of the mobile node may be determined using various methods, non-limiting examples of which, as understood by a person skilled in the art to which it pertains, include using a GPS™ (global positioning system) located within the mobile node (particularly for mobile nodes in Low Earth Orbit and below), receiving location information via ground stations (e.g. Integrated Global Services IGS) or other devices which may track the mobile nodes, using star tracking, using a gyroscope, and using predictive calculations based for example on speed and trajectory of the mobile node, or a combination thereof. Ground stations may track the locations of mobile nodes using a combination of sensors (e.g. laser or radar sensors) and predictive calculations. Mobile nodes may track their own locations using information from ground stations or other mobile nodes, possibly along with predictive calculations.

In embodiments, one, some or all mobile nodes may include a location service module. The location service module may be configured to determine (e.g. periodically or substantially continuously over time) the present physical location of the one or more mobile nodes, for example using various methods as described above. The location service module may further receive (e.g. from a system management module of a mobile node, a ground control station, a control center, another device) a target location request that includes at least the target physical location of at least one mobile node. In response to receiving the target location request, the location service module may be configured to send a target location indication (e.g. to the system management module) when the present physical location of said at least one mobile node is at the target physical location. As such, the location service module may be provided with an indication of a target physical location, and respond by indicating when the mobile node reaches the target physical location.

Alternatively or additionally, the location service module may communicate the present physical location of the at least one mobile node to the system management module, for example in the form of periodic or substantially continuous location updates. In such embodiments (or in other embodiments in which the system management module receives an indication of the present physical location) the system management module may be configured to determine when the present physical location is at the target physical location based at least in part on the indication of the present physical location. The system management module may for example compare the indications of present physical location against a known target physical location. Thus, either the location service module or the system management module may determine whether the mobile node's present physical location is at the target physical location, in order to prompt a service disrupting operation.

In embodiments, the target physical location may be defined as a region (e.g. a portion of an orbit or trajectory, or a region in space) that meets certain criteria related to performing the one or more service disrupting operation. Such criteria may include low (or zero) demand for services provided by the mobile node (e.g. over the ocean, over a low-populated area, near the arctic circle), for example to a user equipment or a network due to the mobile node being over a remote region; the mobile node being sufficiently distanced from equipment which may be inadvertently affected by the service disrupting operation (e.g. shipping lanes, various network based systems); the mobile node being proximate to a specific (e.g. ground) control center, a ground station, or another device; or a combination thereof. The target physical location may be a physical location at which at least one of the one or more mobile nodes involved in the service disrupting operation is proximate to a ground station facilitating the (at least one) service disrupting operation. For example, the service disrupting operation may require a level of communication with the ground station which requires or benefits from such proximity (e.g. due to signal strength, line of sight communication or low latency conditions).

In embodiments, the target physical location may be a physical location at which operational demand on the mobile node or mobile nodes involved in the service disrupting operation is anticipated to be below a predetermined threshold. The threshold may be predetermined for each specific service disrupting operation and may be fixed or adjustable. The threshold may be determined by one or more of: the system management module, a control center external to the mobile node, a ground station, another device (e.g. a system management module of another mobile node), and combinations thereof. For example, the operation may require an outage condition of the mobile node, and in order to mitigate or minimize impact of the outage, the operation may be scheduled to occur when demand is low or when other equipment (e.g. another mobile node) may at least partially compensate for the service disruption during the service disrupting operation affecting the mobile node.

In embodiments, the region defining the target physical location may be a two-dimensional (2-D) geographic region, a geometric region, a geographic point, a geometric region (e.g. 2-D from mobile node point of view), an arc of an orbital path, or a combination thereof. The region may have a uniform boundary, a non-uniform boundary, or a combination thereof. Nearby regions defining different respective target physical locations may be adjacent, may be separated by a gap, may share (e.g. a part of) a region boundary, or may partially overlap. A smaller one or more regions may be included in a larger region. The present physical location of the mobile node being at the target physical location may be deemed to occur when the present physical location is anywhere within the physical, spatial region defining the target physical location, which possibly includes the present physical location being on or at the region boundary.

In embodiments, the target physical location may be determined by one or more of: the system management module, a control center external to the mobile node, a ground station, or another device (e.g. a system management module of another mobile node), or a combination thereof. A target physical location may be defined based for example on a history of operational demand on mobile nodes, at such a location, being below a threshold. The threshold may be an absolute threshold (e.g. defined by demand being below a given value) or a relative threshold (e.g. defined by demand being below a given level which is a percentage of average or maximum demand).

In embodiments, a service disrupting operation may involve more than one mobile node. In this case, the present physical location of some or all of the mobile nodes involved in the service disrupting operation may need to be at the same target physical location (or alternatively at one or more different specific target physical locations) in order for the service disrupting operation to be initiated. Some or all of the mobile nodes may need to be at their respective target physical locations during a portion (or stage) of the service disrupting operation to be completed; during the initiation, commencement and completion of the service disrupting operation; or a combination thereof. For example, the initiation of the service disrupting operation involving several mobile nodes may need two of the mobile nodes to be at their respective target physical locations (which may, for example, be the same target physical location or may overlap or be adjacent to each other). This may be followed by a different stage of the same service disrupting operation, said stage requiring a third mobile node to be at its respective target physical location, and so on. Accordingly, for example, a service disrupting operation involving more than one mobile node may not need all the nodes involved in the service disrupting operation to be at a target physical location at all times, as the service disrupting operation progresses (or goes through its different stages). Such service disrupting operation may, for example, sequentially involve all mobile nodes of the network as they move along their respective paths and are at different target physical locations.

In embodiments, the service disrupting operation may require or be associated with a suspension or reduction in operational capacity of at least one mobile node. The service disrupting operation may be a reconfiguration operation. The service disrupting operation may be a maintenance operation. For example, maintenance may involve taking some mobile node capabilities offline temporarily for reconfiguration, test or restart. Some or all of the services provided by the mobile node may need to be paused, reset, restarted (or continued), either partially or completely, either for the full duration or a part of the duration of the service disrupting operation. Accordingly, and as mentioned above to mitigate operational impact, the system management module may initiate the service disrupting operation (requiring a suspension or reduction in operational capacity of one or more mobile node) based at least in part on the present physical location being at a target physical location.

In embodiments, the service disrupting operation may be initiated, paused, and restarted (or continued) based, at least in part, on the present physical location of the mobile node. The service disrupting operation may be performed, at least in part, while the present physical location of the mobile node is at one location. Different parts of the service disrupting operation may be performed at different, separate time intervals, during each of which the present physical location is at a different one of a plurality of target physical locations. For example, a service disrupting operation may be initiated when the mobile node is at a first target physical location. Then the service disrupting operation may be paused when the mobile node is at a second target physical location, the second target physical location being different from the first. Alternatively or additionally, the service disrupting operation may be paused when the mobile node leaves the target physical location where the service disrupting operation was initiated. The service disrupting operation may be resumed by the system management module based, at least in part, on the present physical location of the mobile node returning to the (original) first target physical location (e.g. after a full orbit) or the present physical location being at a third target physical location different from both the (original) first target physical location and the second target physical location. Thus, the service disrupting operation can be suspended and resumed according to physical location. This may occur for certain types of service disrupting operations, while other types (e.g. requiring a restart) may not necessarily be amenable to such suspend and resume actions. The service disrupting operation can thus proceed intermittently based on location.

In embodiments, the service disrupting (e.g. reconfiguration) operation is a network configuration operation, in which a mobile node is configured to operate according to certain networking protocols. The network configuration operation may include configuring a mobile node to cease providing of a (e.g. cellular) communication service associated with one network (e.g. network provider), and to begin providing of the (e.g. cellular) communication service or another communication service, associated with another network (e.g. network provider). The region may be the target physical location, or the target physical location may correspond to a border or space between regions, as described elsewhere herein. The aforementioned two networks may be deployed in different geographic regions, such as different countries.

The mobile node, moving along its (e.g. orbital) path, may cross different (e.g. geographic, geometric, coordinate) regions, where in each region the services (e.g. cellular communication services) provided by the mobile node to one or more devices (e.g. a user equipment device such as a cellular phone) may be supplied by different services operators. The mobile node may be or act as a gNodeB (also known as gNB, Next Generation Node B), providing direct cellular communication service to user equipment (UE). The UE may connect to the mobile node (e.g. a satellite) using standard protocols and the mobile node may route the UE's traffic to a core network via a ground station either directly or via another one or more mobile nodes until it reaches a suitable ground station.

In embodiments, a mobile node is configured to automatically reconfigure (when at a target physical location) between different operating modes corresponding to different service operators or providers as the mobile node moves between different regions associated with such corresponding service operators or providers. A given operating mode may correspond for example to using certain communication frequencies or protocols (e.g. TDMA or CDMA) used by a corresponding service operator or provider to provide a communication service. A given operating mode may include advertising that the mobile node is providing the communication service, transmitting, and receiving signals according to signaling and protocols associated with the communication service, and generally behaving in a manner aligned with nodes of the corresponding service operator or provider.

In embodiments, a first region may be associated with one network, a second region may be associated with a second network, and the target physical location may be a location between the first region and the second region, for example based on criteria as described elsewhere herein. The first and second regions may be regions in space at which the mobile node is usable as part of the first and second networks, respectively.

In embodiments, mobile nodes of a network are arranged in a geometrically regular mesh configuration that includes communication links between (e.g. neighboring) mobile nodes. Such a configuration is anticipated in satellite networks, as the satellites' orbital positions in a constellation typically must be precisely defined. Hard failures of individual satellites or their links are difficult and expensive to repair in a satellite network, for example from an orbital platform. For example, a problematic satellite would need to be captured and possibly returned to the ground for corrective action. It is also likely that the satellite would need to be replaced. Due to the cost and time required for such service disrupting operation, it is probable that hard failures would accumulate in the network and satellite nodes thereof until action is required.

As an alternative, and in accordance with some embodiments of the present disclosure, mobile node (e.g. satellite) resources can be repurposed to improve the network performance in situ. This may be accomplished by repurposing connections such as inter-satellite links (ISLs), for example as disclosed in U.S. patent application Publication Ser. Nos. 17/226,786 and 17/314,940.

In embodiments, the service disrupting (e.g. reconfiguration) operation may be a mobile node link configuration (e.g. reconfiguration) operation. The link configuration operation may include adjusting of one of one or more mobile nodes, one or more of the links between the mobile nodes (e.g. neighboring nodes sharing a communication link), or a combination thereof, when the at least one of the one or more mobile nodes is at the target physical location.

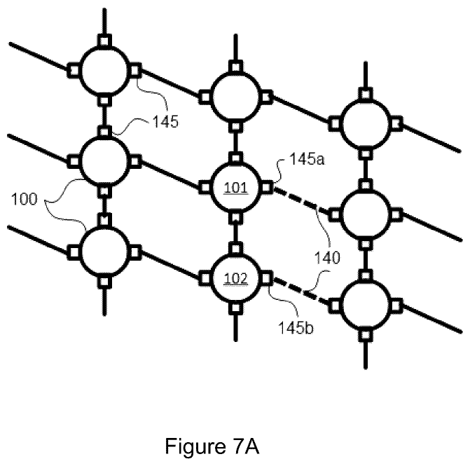

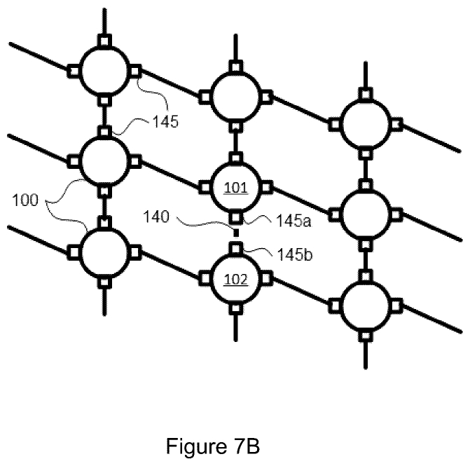

The link configuration operation may be implemented using underlying resources, for example mobile nodes themselves, or components of mobile nodes, or other equipment usable to perform mobile node adjustments or network configuration operations in general, whether physical, electrical or otherwise. The underlying resources can be physical actuators (e.g. thrusters such as propellant rockets) which are capable of rotating the mobile nodes. Instructions may be provided to the mobile node (or relevant systems thereof) that, when implemented, can cause the mobile node to physically reconfigure in order to implement the link configuration. The instructions can cause mobile nodes to adjust operations, such as communication operations, in a manner that implements the network configuration. For example, the adjusting in operations can involve adjusting which communication equipment is used to support a given mobile node link, or which communication channel or frequency is used, or which of a plurality of communication modes (e.g. radio or optical) is used, or the like. The adjustment can depend on what options are available at a specific mobile node for changing aspects that can affect its operations. Reference is made to FIGS. 7A and 7B, which are described in more detail elsewhere herein, in this regard.

In embodiments, the service disrupting (e.g. reconfiguration) operation may be a mobile node configuration operation, a mobile node self-test operation, a mobile node update operation, a restart operation of one or more functions of the mobile node, or a combination thereof.

In embodiments, the mobile node configuration operation may include some or all elements of one or more of the network configuration service disrupting operation and link configuration service disrupting operation, as described elsewhere herein.

In embodiments, the mobile node self-test operation may include testing the node and/or its components and functions for proper operation. The mobile node self-test operation may be routine. The mobile node self-test operation may be scheduled (e.g. based at least in part on the target physical location) for example by the system management module. The results of the mobile node self-test may be communicated by the mobile node to one or more of: the system management module, a control center external to the mobile node, a ground station, another device (e.g. a system management module of another mobile node), or a combination thereof. It is noted that such operations may require a temporary suspension of regular operation, such as communication, sensing or computation, of the mobile node.

In embodiments, the mobile node update operation may include software updates of various components of the mobile node, including the system management module and the location service module.

In embodiments, the restart operation of one or more functions of the mobile node may include shutting down, either fully or in part, the one or more functions of the mobile node, including those of the system management module and the location service module.

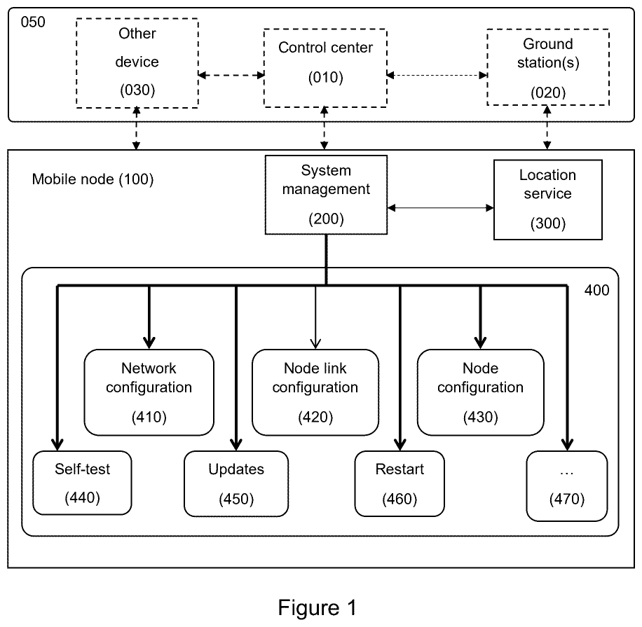

FIG. 1 illustrates a system for scheduling service disrupting operations, according to an embodiment of the present disclosure. A mobile node 100 includes a system management module 200 and a location service module 300 which may be in communication with each other. One or both of the system management module 200 and the location service module 300 may be in communication with an external component 050, such as a control center 010, a ground station 020, and another device 030 (e.g. another mobile node or a component thereof), which are all external to the mobile node 100 and may be involved in or may facilitate some or all functions of the system management module 200 and the location service module 300. The system management module 200 has some or all of the following functions: determining, scheduling, initiating, pausing, and resuming (or initiating a continuation of) one or more service disrupting operations 400. The service disrupting operation 400 may include, for example, a network configuration operation 410; a mobile node link configuration operation 420; a mobile node configuration operation 430; a mobile node self-test operation 440; a mobile node update operation 450; a restart operation 460 of one or more functions of the mobile node; any other service disrupting operation 470 requiring at least partial suspension or reduction in operational capacity of at least one mobile node; or a combination thereof.

In embodiments, the functions of the system management module as described above may include communicating with one or all of the location service module 300, one or more external component 050, and any other component of the mobile node 100 (not shown). Such communicating may include sending and/or receiving information, indications, requests, reports, data, status updates, instructions, and such, as understood by a person skilled in the art to which it pertains. The location service module provides information to the system management module based on, or indicative of, present physical location of the mobile node. The mobile node may include a processor and memory, or equivalent electronics, and at least one communication interface, such as a radio or optical communication transmitter, receiver, or both. These components of the mobile node may be configured to provide the system management module, the location service module, and other functional aspects of the mobile node, such as those functional aspects which are adjusted due to the service disrupting operations.

In embodiments, (initiation, pause, continuation of) service disrupting operations are scheduled based at least in part on the target physical location of one or more of the mobile nodes, depending on how many mobile nodes are involved in or may be affected by a specific service disrupting operation.

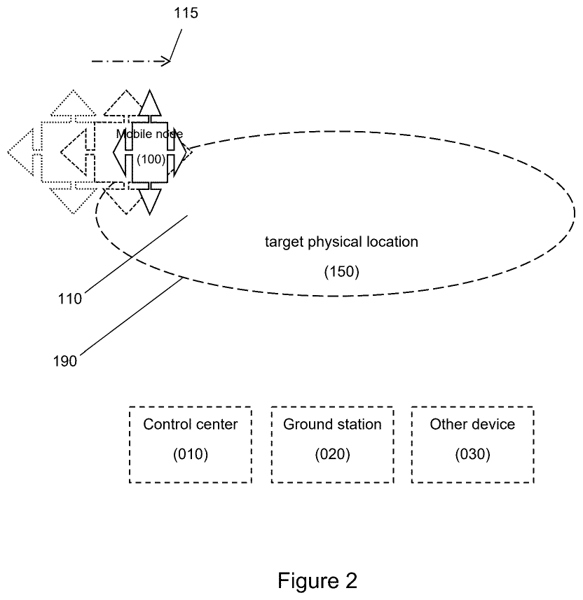

As illustrated in FIG. 2 and according to an embodiment, the mobile node 100 having a present physical location 110 at each moment in time may move along its path 115. As also illustrated, the present physical location 110 of the mobile node 100 is at the target physical location 150 defined by its region boundary 190, as described elsewhere herein. A control center 010, ground station 020, or other device 030 may be located proximate to the target physical location in some, but not necessarily all, embodiments. For example, the target physical location may be a location in Earth orbit which is above such entities.

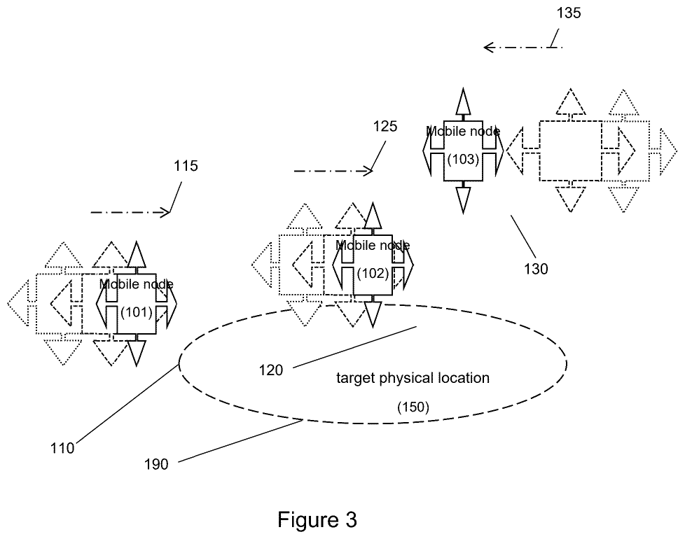

As illustrated in FIG. 3 and according to an embodiment, the present physical location of the mobile node being at the target physical location 150 includes the mobile node being at or within a region boundary 190 of the target physical location 150. For example, a service disrupting operation requiring two mobile nodes may be initiated when both mobile nodes are at the target physical location 150, such as a first mobile node 101 moving along a first path 115 and having a first present physical location 110 at the region boundary 190 of the target physical location 150, and a second mobile node 102 moving along a second path 125 and having a second present physical location 120 within the region boundary 190 of the target physical location 150. In case the present physical location of one of the mobile nodes required for the service disrupting operation is not at the target physical location (e.g. a third mobile node 103 moving along a third path 135 and having a third present physical location 130 outside the region boundary 190 of the target physical location 150), then such service disrupting operation may not be initiated at least until the present physical location of such a mobile node is at the target physical location as required via the scheduled initiation of the service disrupting operation.

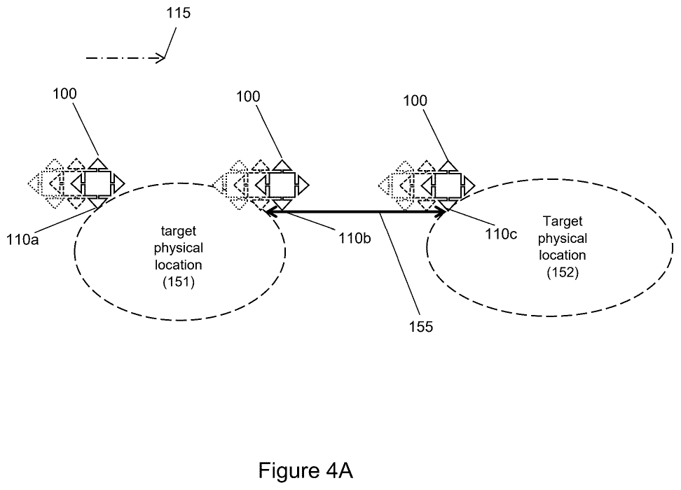

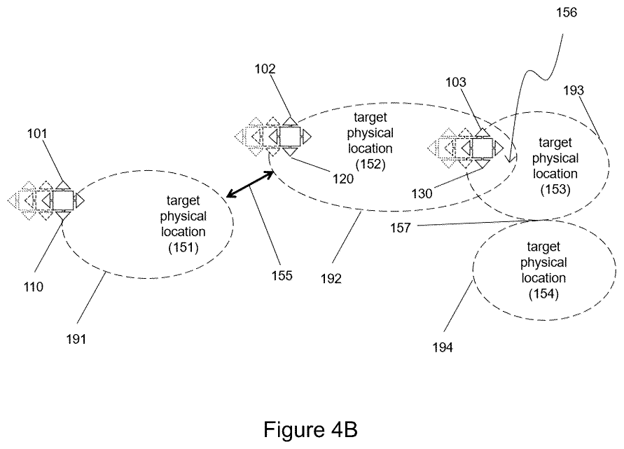

In embodiments, a service disrupting operation may require several mobile nodes (or present physical locations thereof) to be at a same target physical location or at different target physical locations. As illustrated in FIGS. 4A and 4B, target physical locations required for a specific service disrupting operation may be adjacent 157 (FIG. 4B) and share a part of their respective region boundaries (e.g. 193, 194); may be separated by a gap 155 where no service disrupting operation action is triggered; may include an overlap location 156, or a combination thereof (not shown).

In embodiments, a service disrupting operation may take place at different target physical locations. Different parts of the service disrupting operation may take place at different respective ones of the target physical locations. For example, and as illustrated in FIG. 4A, such a service disrupting operation requiring one mobile node may be scheduled to initiate when present physical location 110a of the mobile node 100 is at a first target physical location 151. As the mobile node 100 moves along its path 115, it eventually leaves the first target physical location 151. Such service disrupting operation may be scheduled to pause when the present physical location 110b of the mobile node 100 is not at the first target physical location 151. As the mobile node 100 continues moving along its path 115, it crosses the gap 155 between the first target physical location 151 and a second target physical location 152. The service disrupting operation may be scheduled to continue or resume when the present physical location 110c of the mobile node 100 is at the second target physical location 152.

In another example, and as illustrated in FIG. 4B, a service disrupting operation (e.g. requiring three mobile nodes) may be scheduled to initiate when the first present physical location 110 of the first mobile node 101 is at the first target physical location 151 defined by the first region boundary 191, the second present physical location 120 of the second mobile node 102 is at the second target physical location 152 defined by the second region boundary 192, and the third present physical location 130 of the third mobile node 103 is at the third target physical location 153 defined by the third region boundary 193.

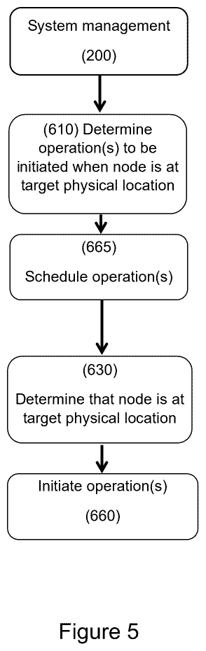

FIG. 5 illustrates an example of operations (also referred to as actions) to schedule a one or more service disrupting operation. The system management module 200 of a mobile node may determine 610 the (one or more) service disrupting operation(s) requiring a suspension or reduction in operational capacity of at least one mobile node to be initiated when the mobile node (or present physical location thereof) is at the target physical location. In embodiments, more than one service disrupting operation may occur (e.g. partially or substantially) simultaneously when the mobile node is at the target physical location. The system management module may schedule 665 the initiation, and if required a (one or more) pause and continuation, of the (one or more) service disrupting operation(s) based at least in part on the present physical location of the at least one mobile node involved in the service disrupting operation being at a target physical location. Scheduling may include specifying that an operation is to occur when a specified condition is satisfied. The system management module may determine 630 (possibly with assistance from the location service module) when the at least one mobile node (and the present physical location thereof) involved in the service disrupting operation is at a target physical location. The system management module may initiate 660 the (one or more) service disrupting operation(s) when the at least one mobile node (and the present physical location thereof) involved in the service disrupting operation(s) is at a target physical location.

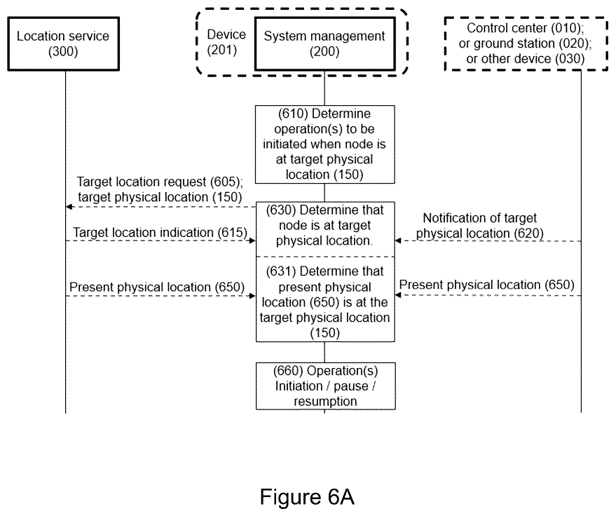

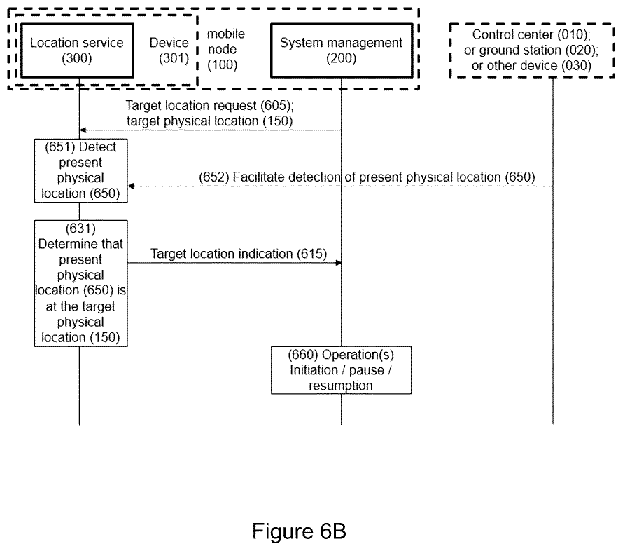

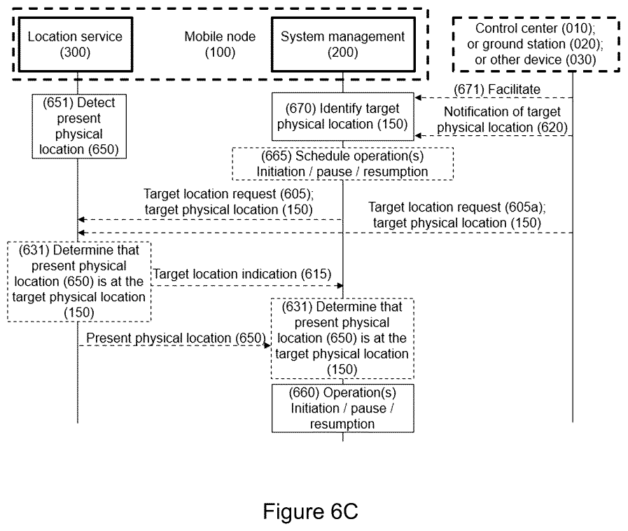

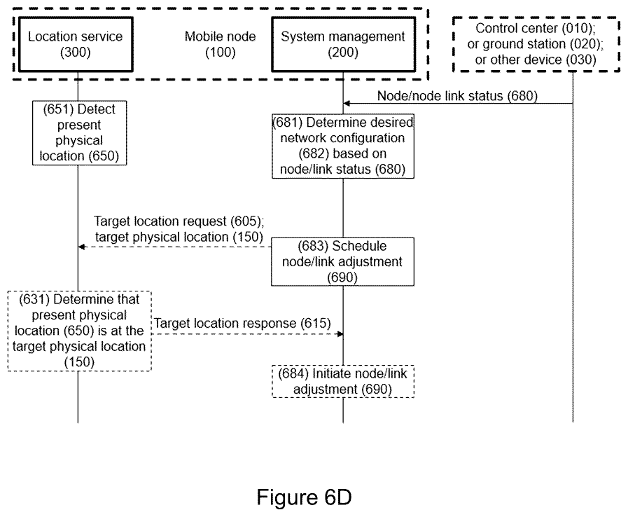

In an illustrative embodiment shown in FIG. 6A, the system management module 200 may be or may be a part of a networked computerized device. Such a system management device 201 may include some or all features of the system management module described elsewhere herein. The system management device 201 (or the system management module 200 thereof) determines 610 a service disrupting operation requiring a suspension or reduction in operational capacity of one or more mobile nodes to be initiated by the system management device when the one or more mobile nodes are at a target physical location.

The system management device 201 (or the system management module 200 thereof) further determines 630 that at least one of the mobile nodes is at the target physical location. Such determining may include receiving a notification 620 of the target physical location from a control center 010, a ground station 020, another device 030, or a combination thereof. Such notification 620 may include an identification of at least one target physical location. Accordingly, the target physical location itself can be dictated to the system management device, e.g. separately from the present physical location. Such notification 620 may include one or more service disrupting operation associated with the at least one target physical location included therein. Such determining may include receiving by the system management device 201 (e.g. an indication of) a present physical location 650 of the one or more mobile nodes from one or more of: the control center 010; a location service module 300 of the associated mobile node, the ground station 020, the other device 030, or a combination thereof. The system management device 201 may then determine 631, as it receives (e.g. periodic or substantially continuous) information on the present physical location 650 of the one or more mobile nodes, that the present physical location 650 of these one or more mobile nodes is at the target physical location 150.

In some embodiments, the notification 620 of target physical location and (e.g. an indication of) the present physical location 650 can be combined together. For example, the control center 010, a ground station 020, other device 030 can message the system management device 201 to indicate that the mobile node's present physical location is at the target physical location.

In embodiments, the features of the present physical location 650 may be substantially the same as features of the present physical location and specific instances thereof, as described elsewhere herein (e.g. 110, 120, 130, 110a, 110b, 110c in FIGS. 2, 3, 4A, 4B and 4C).

In some embodiments, in order to determine 630 that the one or more mobile node is at the target physical location, the system management device 201 may send a target location request 605 to the location service module 300 that includes the target physical location 150 of the one or more mobile node. The system management device 201 may further receive a target location indication 615 from the location service module 300. The target location indication 615 is sent by the location service module when at least the present physical location 650 of the one or more mobile nodes is at the target physical location 150.

After determining 630 that that the one or more mobile node is at the target physical location, the system management device 201 can initiate 660 the scheduled service disrupting operation.

Accordingly, there are at least two different routes to initiating 660 the scheduled service disrupting operation. In a first route, the location service module 300 determines that the mobile node is at the target physical location and sends the target location indication 615, resulting in the determination 630 that the mobile node is at the target physical location. In a second route, the location service module 300 (or another device) sends present physical location updates 650, on the basis of which the system management module 200 determines 631 that the present physical location is at the target physical location. Either one or both of these routes may be utilized.

In embodiments, the initiating 660 of the scheduled service disrupting operation may include, additionally or alternatively, pausing and resuming (continuing) of the scheduled service disrupting operation.

In an illustrative embodiment shown in FIG. 6B, the location service module 300 may be or may be a part of a networked computerized device 301 of the mobile node 100. Such location service device 301 may include some or all features of the location service module 300 described elsewhere herein. The location service device 301 (or the location service module 300 thereof) receives a target location request 605 that includes a target physical location 150 of the mobile node from a system management module 200 of the mobile node 100. The location service device 301 (or the location service module 300 thereof) may detect 651 (e.g. determine, track, monitor, obtain information that includes) a present physical location 650 of the mobile node 100, for example periodically or substantially continuously. Such detecting 651 may be facilitated 652 by one or more of: a control center 010; a ground station 020, another device 030, or a combination thereof. For example, a ground station may track the present physical location of the mobile node and transmit corresponding indications of the mobile node location.

As further shown in FIG. 6B, the location service device 301 (or the location service module 300 thereof) determines 631 if the detected present physical location 650 of the mobile node 100 is at the target physical location 150. The location service device 301 (or the location service module 300 thereof) also sends a target location indication 615 that includes an indication that the present physical location 650 of the mobile node 100 is at the target physical location 150. The target location or indication 615 thereof is sent to the system management module 200. The system management module 200, at least in part in response to receiving the target location indication 615, initiates 660 at least one (e.g. scheduled) service disrupting operation associated with the present physical location 650 of the mobile node 100 being at the target physical location 150.

In an illustrative embodiment shown in FIG. 6C, operations or actions are provided for scheduling service disrupting operations. The method includes identifying 670, by a system management module 200 of at least one mobile node 100, a target physical location 150 of the at least one mobile node 100. Such identifying 670 may be facilitated 671 by one or more of: a control center 010; a ground station 020, another device 030, or a combination thereof, for example by sending relevant information or request to the system management module 200. Facilitating may include transmitting a message with relevant information, such as a notification 620 of the target physical location described elsewhere herein.

As further shown in FIG. 6C, the method includes determining 651 (e.g. detecting, tracking, monitoring, obtaining information that includes) a present physical location 650 of the at least one mobile node 100 by a location service module 300 of the at least one mobile node 100. Such determining may be ongoing, e.g. periodic or substantially continuous in time.

As further shown in FIG. 6C, the method includes scheduling 665 by the system management module 200, based at least in part on the target physical location 150, one or more of: at least one service disrupting operation; a pause of the at least one service disrupting operation; and a continuation of the at least one service disrupting operation, or a combination thereof.

As further shown in FIG. 6C, the method includes sending, by the system management module 200, a target location request 605 that includes at least the target physical location 150 of the at least one mobile node to the location service module 300.

As further shown in FIG. 6C, the method includes receiving, by the location service module 300, a target location request 605 from the system management module 200, or a target location request 605a from an external component (e.g. control center 010, ground station 020, another device 030), or both, the target location request 605, 605a comprising at least the target physical location 150 of the at least one mobile node 100. In response to receiving the target location request 605 and further in response to the present physical location 650 reaching the target physical location 150, the location service module 300 may send a target location indication 615 to the system management module 200. Additionally or alternatively to sending the target location indication 615, the location service module 300 may communicate (e.g. periodically or substantially continuously) to the system management module 200 the present physical location 650 of the at least one mobile node 100. The system management module 200 may receive such communicated information for example as an indication of the present physical location 650 of the at least one mobile node 100 and use it to determine 631 that the present physical location 650 is at the target physical location 150 based at least in part on such indication.

Either in response to its own determination 631 that the present physical location 650 is at the target physical location 150, or in response to receiving an equivalent indication via the target location indication 615, the method includes initiating 660, by the system management module 200, the at least one service disrupting operation. Thus, the service disrupting operation is based at least in part on the present physical location 650 of the at least one mobile node 100 being at the target physical location 150.

In an illustrative embodiment shown in FIG. 6D, operations or actions are provided for scheduling network service disrupting operations. The system management module 200 of a mobile node 100 can obtain (receive e.g. following sending a corresponding request) information 680 indicative of a current status of mobile nodes of the network, links between the mobile nodes, or a combination thereof. The system management module 200 can process the obtained information 680 to determine 681 a network configuration 682 based on the obtained information 680. Such network configuration 682 can be implemented in the network by adjusting 690 one or more of the mobile nodes 100, one or more of the links between the mobile nodes 100, or a combination thereof. Such adjusting 690 may include some or all features of the service disrupting operation, as described elsewhere herein. The system management module 200 can schedule 683 such adjusting 690 to be implemented when the one or more mobile nodes 100 are in a target physical location 150. Alternatively, the control center 010, ground station 020 or other device 030 may make the determination 681 and provide this information to the system management module 200.

As further shown in FIG. 6D, in order to schedule 683 such adjusting 690 based, at least in part, on the target physical location 150 of the one or more mobile nodes 100, the system management module 200 may send a target location request 605 to a location service module 300 of the (e.g. associated) mobile node 100. The target location request 605 may include at least the target physical location 150 of the mobile node 100 involved in the adjusting 690. The location service module 300 can determine 651 at least a present physical location 650 of the mobile node 100. After receiving the target location request 605 that includes the target physical location 150, the location service module 300 can determine 631 when the present physical location 650 of the mobile node 100 is at the target physical location 150. Once the location service module 300 makes such a determination 631, it may send a target location indication 615 to the system management module 200, indicating that the present physical location 650 of the mobile node 100 is at the target physical location 150 included in the target location request 605.

As further shown in FIG. 6D, the system management module 200, in response to receiving the target location indication 615, may initiate 684 the adjusting 690 of the one or more of the mobile nodes 100, one or more of the links between the mobile nodes 100, or a combination thereof, for example according to scheduling 683. Alternatively, the system management module 200 may determine that the present physical location of the mobile device is at the target physical location in a different manner, as described elsewhere herein.

FIGS. 7A and 7B illustrate an example embodiment of mobile nodes 100 arranged in a geometric mesh where neighboring nodes are in communication with each other via node links (e.g. inter-satellite links or ISLs). Each of the mobile nodes 100, represented by a circle and including mobile node instances 101, 102 has four instances of underlying resources 145 (e.g. point-to-point communication links), as described elsewhere herein. The number and capabilities of each underlying resource of each mobile node may vary.

The dashed lines in FIG. 7A represent two non-functioning node links 140 of adjacent first mobile node 101 where the node link failure is caused by a malfunction of a corresponding first underlying resource 145a, and a second mobile node 102 where the node link failure is caused by a malfunction of a corresponding second underlying resource 145b. A link configuration operation, or an example instance of link reconfiguration thereof, described elsewhere herein, may be implemented to cause the mobile nodes 101, 102 to repurpose their respective malfunctioning underlying resources 145a, 145b, for example in order to improve the overall mobile node network performance. As shown in FIG. 7B, the first underlying resource 145a and the second underlying resource 145b are configured to form a single non-functioning node link 140 which effectively replaces the link configuration shown in FIG. 7A where two non-functioning node links 140 are present. Such link configuration operation may be scheduled to be initiated for example when the first mobile node 101 and the second mobile node 102 are both in the same (e.g. defined by a sufficiently large region boundary of the target physical location) target physical location. Alternatively, such link configuration operation may be scheduled to be initiated for example when the first mobile node 101 (and the present physical location thereof) is at a first target physical location and the second mobile node 102 (and the present physical location thereof) is at a second target physical location, for example if no suitable target physical location can be determined to accommodate both mobile nodes.

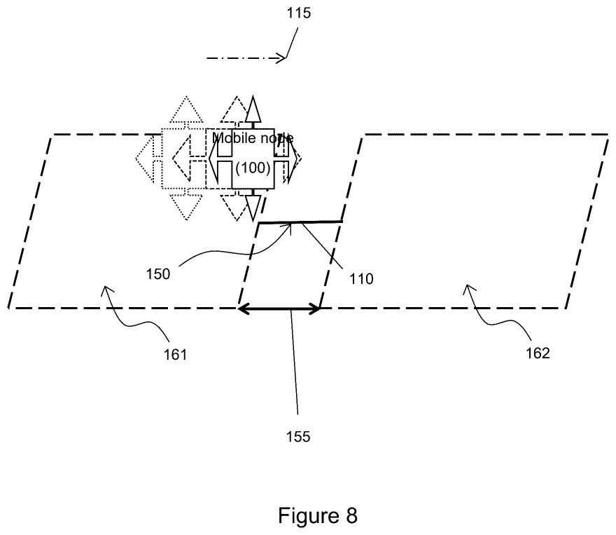

As shown in FIG. 8, a network configuration operation, described elsewhere herein, may be initiated when the present physical location 110 of the mobile node 100 moving along its path 115 is between a first region 161 and a second region 162. The first region 161 and the second region 162 may be separated by a gap 155 or may be adjacent (not shown). A target physical location 150 for the initiation of the network configuration operation may be defined to span the gap 155 along the path 115 of the mobile node 100. If the first region 161 and the second region 162 are adjacent (i.e. border each other), then the target physical location may be defined substantially as a physical point (e.g. a geographic coordinate having a latitude and longitude value) intersecting the path 115 of the mobile node 100 (not shown). If the first region 161 and the second region 162 overlap (not shown), then the target physical location may be defined substantially as having a boundary defined by the overlap between the first region and the second region (e.g. overlap location 156 in FIG. 4B). The first region 161 and the second region 162 may be regions in which services of the mobile node 100 are required, so it is desirable to perform service disrupting operations when the mobile node is between these regions, i.e. in the gap 155.

It is considered that service disrupting network maintenance and reconfiguration is a significant driver of operating expense. Techniques that reduce operations cost can therefore be highly desirable. Embodiments of the present invention may reduce operating costs by reducing the impact of service disrupting operations, for example by causing these operations to occur when mobile nodes are at a particular location at which such operations have limited service impact. The operations are scheduled based on mobile node location rather than time. Global operation scheduling may be performed to occur at “off-peak” geographic locations, rather than based on specific times. Furthermore, embodiments mitigate or avoid a need to map mobile node locations to time of day for scheduling purposes.

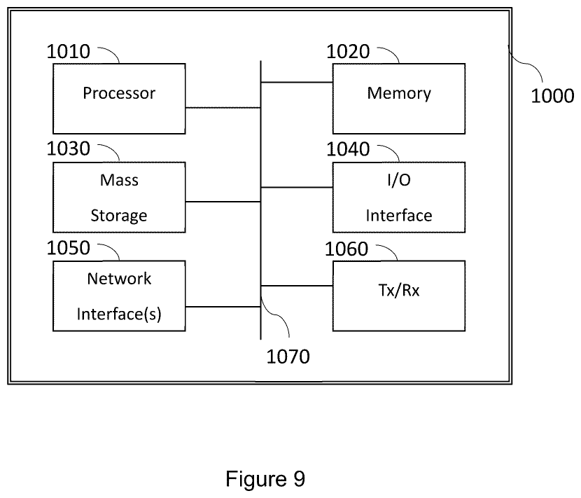

FIG. 9 is a schematic diagram of an electronic device 1000 that may perform any or all of operations of the above methods and features explicitly or implicitly described herein, according to different embodiments of the present disclosure. For example, a computer equipped with network function may be configured as electronic device 1000.

As shown, the device includes a processor 1010, such as a Central Processing Unit (CPU) or specialized processors such as a Graphics Processing Unit (GPU) or other such processor unit, memory 1020, non-transitory mass storage 1030, I/O interface 1040, network interface 1050, and a transceiver 1060, all of which are communicatively coupled via bi-directional bus 1070. According to certain embodiments, any or all of the depicted elements may be utilized, or only a subset of the elements. Further, the device 1000 may contain multiple instances of certain elements, such as multiple processors, memories, or transceivers. Also, elements of the hardware device may be directly coupled to other elements without the bi-directional bus. Additionally or alternatively to a processor and memory, other electronics, such as integrated circuits, may be employed for performing the required logical operations.

The memory 1020 may include any type of non′-transitory memory such as static random access memory (SRAM), dynamic random access memory (DRAM), synchronous DRAM (SDRAM), read-only memory (ROM), any combination of such, or the like. The mass storage element 1030 may include any type of non-transitory storage device, such as a solid state drive, hard disk drive, a magnetic disk drive, an optical disk drive, USB drive, or any computer program product configured to store data and machine executable program code. According to certain embodiments, the memory 1020 or mass storage 1030 may have recorded thereon statements and instructions executable by the processor 1010 for performing any of the aforementioned method operations described above.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

1. A networked computerized system for scheduling service disrupting operations, the system comprising:
one or more non-terrestrial mobile nodes of a network, at least one of the one or more mobile nodes comprising:
a location service module configured to determine a present physical location of said at least one of the one or more mobile nodes; and
a system management module configured to initiate at least one service disrupting operation based at least in part on the present physical location being at a target physical location, the at least one service disrupting operation requiring a suspension or reduction in operational capacity of said at least one of the one or more mobile nodes.

2. The system of claim 1, wherein the system management module schedules, based at least in part on the target physical location, one or more of: the at least one service disrupting operation; a pause of the at least one service disrupting operation; and a continuation of the at least one service disrupting operation.

3. The system of claim 1, wherein the target physical location is one of:
a physical location at which operational demand on said at least one of the one or more mobile nodes is anticipated to be below a predetermined threshold, or
a physical location at which said at least one of the one or more mobile nodes is proximate to a ground station facilitating the at least one service disrupting operation.

4. The system of claim 1, wherein the system management module is further configured to send a target location request to the location service module, the target location request comprising at least the target physical location of said at least one of the one or more mobile nodes.

5. The system of claim 1, wherein the location service module is further configured to receive a target location request from the system management module, or a ground control center, or both, the target location request comprising at least the target physical location of said at least one of the one or more mobile nodes.

6. The system of claim 4, wherein the location service module is further configured, in response to receiving the target location request, to send a target location indication to the system management module, when the present physical location of said at least one of the one or more mobile nodes is at the target physical location.

7. The system of claim 1, wherein the location service module is further configured to communicate at least one of: the present physical location, and an indication that the present physical location is at the target physical location, to the system management module.

8. The system of claim 1, wherein the system management module is further configured to:
receive an indication of the present physical location of said at least one of the one or more mobile nodes from the location service module; and
determine that the present physical location is at the target physical location based at least in part on the indication of the present physical location.

9. The system of claim 1, wherein the system management module is further configured to pause the at least one service disrupting operation based at least in part on the present physical location of said at least one of the one or more mobile nodes leaving the target physical location or the present physical location being at a second target physical location different from the target physical location.

10. The system of claim 9, wherein the system management module is further configured to resume the at least one service disrupting operation based at least in part on the present physical location of said at least one of the one or more mobile nodes returning to the target physical location or the present physical location being at a third target physical location different from the target physical location and the second target physical location.

11. The system of claim 1, wherein the service disrupting operation is a network configuration operation, the network configuration operation comprises:
configuring said at least one of the one or more mobile nodes to cease providing of a communication service associated with a first network of a first region, and to begin providing of the communication service or another communication service, associated with a second network of a second region.

12. The system of claim 11, wherein the first region is associated with the first network, the second region is associated with the second network, and the target physical location is between the first region and the second region.

13. The system of claim 1, wherein the service disrupting operation is a mobile node link configuration operation, the mobile node link configuration operation comprises:
adjusting said at least one of the one or more mobile nodes, one or more of the links between the mobile nodes, or a combination thereof, when said at least one of the one or more mobile nodes is at the target physical location.

14. The system of claim 1, wherein the service disrupting operation is one or a combination of: a mobile node configuration operation; a mobile node self-test operation; a mobile node update operation; and a restart operation of one or more functions of said at least one of the one or more mobile nodes.

15. A system management networked computerized device configured to:
determine at least one service disrupting operation to be initiated by the system management device when one or more non-terrestrial mobile nodes of a network are at a target physical location, the at least one service disrupting operation requiring a suspension or reduction in operational capacity of the one or more mobile nodes;
determine that at least one of the one or more mobile nodes is at the target physical location; and
in response to said determining that said at least one of the one or more mobile network nodes is at the target physical location, initiate the at least one service disrupting operation.

16. The system management device of claim 15, wherein said determining that said at least one of the one or more mobile nodes is at the target physical location comprises receiving a notification of the target physical location from a control center or another device.

17. The system management device of claim 15, wherein said determining that said at least one of the one or more mobile nodes is at the target physical location comprises one of:
receiving an indication of a present physical location of said at least one of the one or more mobile nodes from one or more of: a control center; a location service module of said at least one of the one or more mobile nodes; and another device, or
sending a target location request to a location service module, the target location request comprising the target physical location of said at least one of the one or more mobile nodes.

18. The system management device of claim 17, further configured to:
receive a target location indication from the location service module when the present physical location of said at least one of the one or more mobile nodes is at the target physical location.

19. The system management device of claim 17, wherein said determining that said at least one of the one or more mobile nodes are at the target physical location comprises determining that the present physical location of said at least one of the one or more mobile nodes is at the target physical location.

20. A location service networked computerized device configured to:
receive a target location request from a system management module of a non-terrestrial mobile node of a network, the target location request comprising a target physical location of the mobile node;
determine if the present physical location of the mobile node is at the target physical location; and
send a target location indication to the system management module when the present physical location of the mobile node is at the target physical location;
wherein the system management module, in response to receiving the target location indication, initiates at least one service disrupting operation;
wherein the location service device is located within the non-terrestrial mobile node of the network.
